(19) United States
(12) Patent Application Publication
(10) Pub. No.: US 2013/0056982 A1
(43) Pub. Date: Mar. 7, 2013

(54) Gas Turbine Generator

(71) Applicant: Richard Gozdawa, Uxbridge (GB)

(72) Inventor: Richard Gozdawa, Uxbridge (GB)

(21) Appl. No.: 13/516,738

(22) PCT Filed: Dec. 16, 2010
(86) PCT No.: PCT/GB10/52108

§ 371 Date: Nov. 19, 2012

(30) Foreign Application Priority Data
Dec. 17, 2009 (GB) 0922004.7

(51) Int. Cl. H02K 7/18; F02D 29/06

(52) U.S. Cl. 290/7; 290/52

(57) ABSTRACT

A gas turbine generator 1 comprising a combustor (2), a turbine (4), a compressor (6), a drive shaft (7) and at least one generator. The turbine (4) is driven by the combustor (6). The drive shaft (7) links the turbine (4) and the compressor (6) along a common rotational drive axis. The at least one electrical generator comprises a rotor and a stator, and the rotational axis of the generator rotor is radially offset from the drive axis. Drive means is provided which connects the generator rotor to the drive shaft (7) such that rotation of the drive shaft (7) causes rotation of the generator rotor.

The present invention relates to gas turbine generator and in particular a gas turbine generator including multiple offset generators.

Conventional gas turbine generators comprise a combustion driven turbine coupled to a generator unit via a gear box. Typically power generation is achieved by a permanent magnet generator including a permanent magnet rotor, located within a stator coil, which is aligned with and driven by the turbine drive shaft via the gear box. The power output of such generator assemblies is determined by the size of the permanent magnet rotor, with increased power output requiring an increased rotor length. As such, power output is limited by the critical length of the rotor, which represents the maximum achievable length of the rotor above which the magnetic core becomes damaged by the vibrations generated by the high rotational speeds required by the permanent magnet generator.

It is possible to mitigate this damage to some extent by encasing the magnetic core in a protective carbon fibre sleeve which is push fitted onto the magnetic core. However, as the rotor length increases the sleeve can no longer be push fitted onto the core due to increased friction, and must instead be formed about the core and subsequently pre-stressed by heating in an oven to over 100° C., leading to degeneration of the magnetic strength of the core, and hence decreased generator performance. In addition, the size of the rotor required for higher power outputs leads to a prohibitive overall unit size for the generator. For example, 1.4 MW gas turbine generator will typically require a support skid over 6.5 m in length and weighting over 25 tons. This presents difficulties in aligning the generator rotor, and the drive shafts of the gear box and the turbine, due to the weight of the components involved.

It is therefore desirable to provide an improved gas turbine generator which addresses the above described problems and/or which offers improvements generally.

According to the present invention there is provided a gas turbine generator as described in the accompanying claims.

In an embodiment of the invention there is provided a gas turbine generator comprising a combustor, a turbine, a compressor, a drive shaft and at least one generator. The turbine is driven by the combustor. The drive shaft links the turbine and the compressor along a common rotational drive axis. The at least one electrical generator comprises a rotor and a stator, and the rotational axis of the generator rotor is radially offset from the drive axis. Drive means is provided which connects the generator rotor to the drive shaft such that rotation of the drive shaft causes rotation of the generator rotor. In this way, the generator may be oriented back towards the turbine, and positioned such that it is axially in line with the drive shaft, thereby substantially reducing the overall length of the gas turbine generator. In contrast, in gas turbine generators of the prior art, the generator shares a common axis of rotation with the turbine and is therefore essentially positioned in line with the drive shaft. As such, the generator must extend beyond the drive shaft thereby extending the overall length and weight of the gas turbine generator.

The rotor preferably comprises a permanent magnet, which may be at least partially surrounded by a sleeve configured to urge the magnet against the rotor shaft to prevent damage to the magnet during rotation. The rotational axis of the generator rotor may be oriented substantially parallel to the drive axis, thereby providing a compact arrangement which minimises the overall generator size.

The drive means may comprise a drive gear connected to and axially aligned with the drive shaft, and a rotor gear connected to the at least one generator rotor and linked to the drive gear such that rotation of the drive gear by the drive shaft causes rotation of the rotor gear and hence the rotor. This enables rotational drive to be transferred to the radially offset generator.

The gas turbine generator may further comprise an idler gear intermediate the drive gear and the generator gear. The idler gear may be mounted on a flexible gear support configured to permit self-alignment of the idler gear. This accommodates any misalignment between the rotor gear and the drive gear.

The at least one generator may comprise a plurality of electrical generators, the rotational axes of the plurality of generators being radially spaced from the drive axis. Providing a plurality of generators enables the power output to be selectively varied by deactivating one or more of the generators depending on the required power output. In addition, a larger power output is achieved while minimising the length of each rotor, thereby preventing magnet damage and minimising weight. In this way a power output may be achieved which in a single linear rotor arrangement would otherwise require a rotor of excessive length, leading to problems in preventing damage of the rotor and also alignment problems due to the weight and linear positioning of the rotor.

The plurality of generators are axially positioned in line with at least a portion of the drive to shaft. By orienting and positioning the generators such that they at are at least partially axially aligned with the drive shaft, rather than extending axially onwards from the drive shaft, the length of the gas turbine generator is substantially reduced.

Each of the plurality of electrical generators may be selectively and independently deactivated to vary the total electrical power output of the gas turbine generator. In this way, the generator may easily and rapidly respond to varying load requirements by selectively deactivating the plurality of generators while maintaining the turbine at optimum drive speed, rather than varying the turbine speed/power to vary the power output of a single linearly arranged generator.

Each of the plurality of electrical generators may be provided with a dedicated power control unit which is used to selectively deactivate the electrical generator. In addition, the gas turbine generator may further comprise a controller connected to each of the power control units and configured to cause the power control units to selectively deactivate one or more of the electrical generators based on a required power output for the gas turbine generator.

In another embodiment of the invention there is provided a gas turbine generator comprising a combustor; a turbine driven by the combustor, a compressor driven by the turbine; and a plurality of electrical generators driven by the turbine. The plurality of generators are driven by the turbine via a drive train.

Each of the electrical generators may be removably coupled to the drive train such that it may be selectively mechanically decoupled from the drive train. In this way the maximum power output of the generator may be pre-set by configuring the number of generators prior to activation.

In another embodiment of the invention there is provided a gas turbine generator comprising a combustor, a turbine driven by the combustor; a compressor; an electrical generator driven by the turbine, and a drive shaft for linking the turbine and the compressor, the drive shaft having a first end configured for connection to the turbine and an opposing second end configured for connection the compressor, wherein at least one of the first and second ends comprises a mechanically interlocking connector configured to allow sliding disengagement of the drive shaft from at least one of the turbine and the compressor respectively. The interlocking sliding connection enables the drive shaft, the compressor and the turbine to be easily decoupled from each other for maintenance or repair.

The mechanically interlocking connector may comprise a spline formed on one of the drive shaft and the at least one of the turbine and the compressor which is configured to be received within a corresponding mating section on the other of the drive shaft and the at least one of the turbine and the compressor. The spline fitting enables easy disassembly while also ensuring secure transferal of rotational force.

Both the first and second ends of the drive shaft may comprise splines configured to be received within corresponding mating sections on the turbine and the compressor respectively.

The at least one generator may be driven by the turbine via a drive train and may be connected to the drive train by an interlocking mechanical connector which enables sliding disengagement of the generator from the drive train. Preferably the interlocking mechanical connector comprises a plurality of spigots extending from one of the generator and the drive train which are received within corresponding apertures on the other of the generator and the drive train enabling sliding disengagement of the two.

The present invention will now be described by way of example only with reference to the following illustrative figures in which:

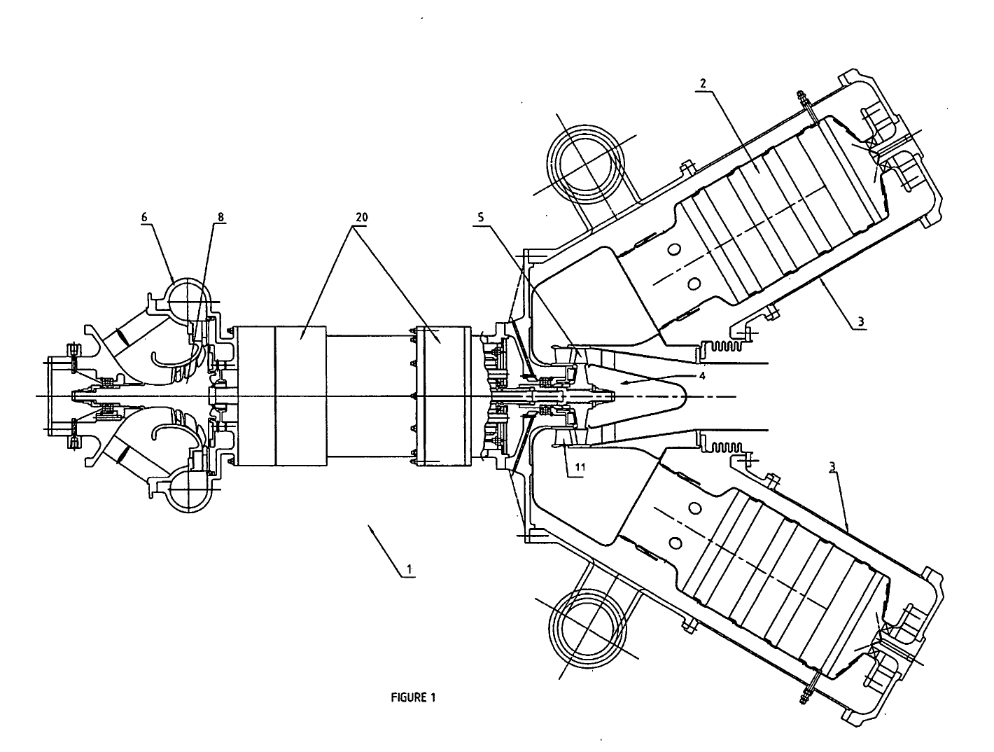

FIG. 1 shows cross sectional view of a gas turbine generator according to an embodiment of the invention taken along the longitudinal axis; and

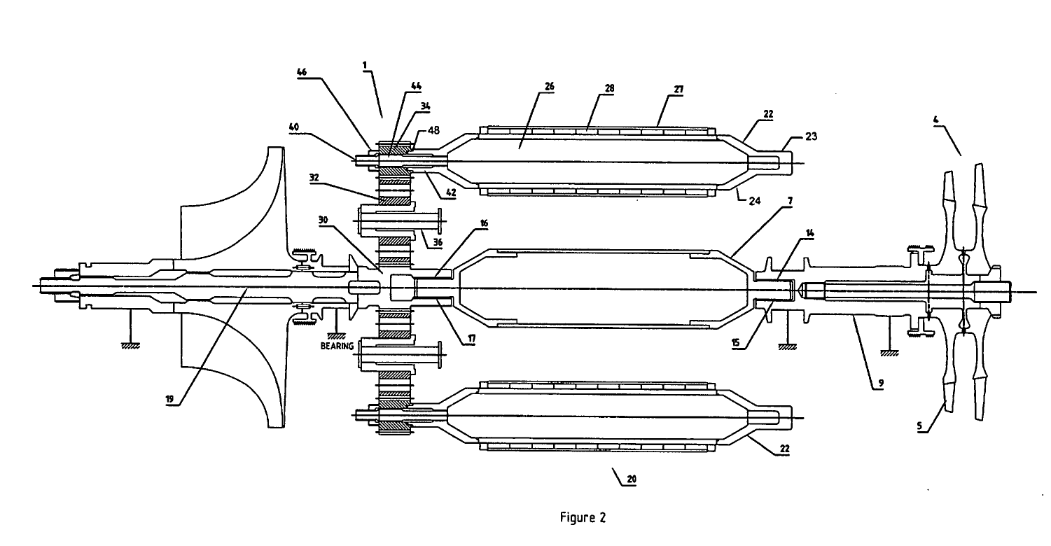

FIG. 2 shows the gas turbine generator of FIG. 1 with the combustors and generator casing not shown.

Referring to FIG. 1, a recuperative gas turbine generator 1 comprises a combustor 2, a turbine 4, a compressor 6 and a generator unit 20. The combustor 2 comprises multiple combustion chambers 3 each arranged to direct high velocity combustion gases through the turbine inlet nozzle 11 and over the blades 5 of the turbine 4, to cause the turbine 4 to rotate. The turbine 4 is connected to a drive shaft 7 which is connected at its opposing end to the compressor 6. Rotation of the turbine 4 causes the impellor 8 of the compressor 8 to rotate, which in turn causes a flow of compressed air to be directed downstream to liner of the combustor 2.

The turbine 4 and compressor 6 are supported in hybrid fluid multi lobe bearings, to provide suitable damping, heat transfer and improved operational lifespan. As shown in FIG. 2, the drive shaft 7 connects the turbine 4 and the compressor 6. The drive shaft 7 is preferably formed from a composite carbon fibre material, which provides a high strength-to-weight ratio. The drive shaft 7 comprises a splined connector section 14 at one end which interlocks with a corresponding mating section 15 at the end of the central shaft section 9 of the turbine 4, although it will be appreciated that this arrangement could be reversed. This splined engagement rotationally locks the drive shaft 7 to the turbine shaft 9, to enable rotational drive from the turbine 4 to be transferred to the drive shaft 7, while also allowing the turbine 4 to be slidingly disconnected from the drive shaft 7 for maintenance or repair.

The opposing end of the drive shaft 7 includes also includes a splined connector section 16 which interlocks with a corresponding mating section 17 of a master drive gear 30 which is coaxial with the drive shaft. Again this arrangement could be reversed. The drive gear 30 is connected on its opposing side to the central shaft section 19 of the compressor 6. The splined engagement rotationally locks the drive shaft 7 to the drive gear 30, and hence to the compressor 6, to enable rotational drive from the drive shaft 7 to be transferred to the drive gear 30 and the compressor 6. In addition, the splined connection enables the compressor 6 and drive gear 30 to be slidingly disconnected from the drive shaft 7 for maintenance or repair.

The generator unit 20 comprises four separate 500 kW generators 22, providing the generator with a power rating of 2 MW. Each of the generators 22 weighs approximately 18 kg. The generators 22 are arranged radially about and adjacent to the drive shaft 7, and are arranged such that their rotational axis is parallel with the axis of rotation of the drive shaft 7. The number and power rating of the generators 22 may be varied depending on the required maximum power output for the gas turbine generator 1, with two, three, or greater than four generators also being possible. Each generator 22 includes a rotor 23 and a stator coil (not shown) disposed about the rotor 23.

The rotor 23 includes a hollow bodied rotor shaft 24 supported on anti friction bearings to minimize parasitic losses. In addition, squeeze film dampers are provided to attenuate any unbalanced response and bearing transmitted forces. A permanent magnet 28 such as a ceramic magnet is mounted on the rotor shaft 24. A carbon fibre sleeve 27 surrounds the permanent magnet 28. The carbon fibre sleeve 27 is shrunk fitted onto the magnet 28 and holds the magnet 28 tight against the rotor shaft 24 and retains the magnet 28 on the rotor shaft at the design over speed of the generator 22. Rotation of the rotor 23 within the stator coil generates a current in the stator coil, with the size of the magnet 28 and the speed of rotation of the rotor 23 determining the power output of the generator.

A high speed rotor gear 34 is mounted to the proximal end of the rotor shaft 24. A tie bolt 40 is connected to the proximal end of the rotor shaft 24 and extends through the rotor gear 34. The tie bolt includes a spline section 44 to rotationally fix it to the rotor gear 34. An outer portion 42 of the proximal end of the rotor shaft 24 includes a plurality of spigots 48 which are received within the inner face of the rotor gear 34. A nut 46 threaded to the tie bolt 40 engages the outer face of the rotor gear 34 to lock the rotor gear 34 between the outer portion 42 of the rotor shaft 24 and the nut 46. This arrangement enables the generator 22 to be easily slidingly disengaged from the gear 34 for repair or maintenance by releasing the nut 46 and sliding the spigots 48 from the inner face of the rotor gear 34.

The rotor gear 34 is aligned with the master drive gear 30 on the drive shaft 7. An idler gear 32 is provided intermediate the drive gear 30 and the rotor gear 34. The idler gear 32 I mounted on a self aligning flexible pin support 36 which compensates for any misalignment between the drive gear 30 and the rotor gear 34. A drive train is thus created between the turbine 4 and the generator 20 comprising the drive shaft 7, the drive gear 30, idler gear 32, and rotor gear 34. The drive gear 30 is directly driven by the drive shaft 7, and transfers rotational drive to the rotor gear 34 via the idler gear 32. The operational speed of the rotor 23 my therefore be predetermined by selecting an appropriate gear ratio between the drive gear 30 and the rotor gear 34. In this way, both the turbine 4 and the generators 22 may be operated at their optimum speeds. This arrangement also enables different gear ratios to be provided for each of the generators 22 to enable different operational speeds depending on the system requirements, and increasing the flexibility of gas turbine generator 1. Furthermore, each of the generators 22 may be easily replaced by alternative generators 22 having a different power rating, with the replacement generator 22 being able to easily integrate with the drive infrastructure of the gas turbine generator 1 through selection of the appropriate rotor gear 34.

Each generator 22 is provided with a dedicated power conditioning unit (PCU). Each PCU is an electronic system which converts the variable high-frequency AC output of the high speed generator into a fixed frequency AC output for either grid-interconnected or stand-alone application. The PCU employs a high speed rectifier arrangement to provide a high voltage DC link to an inverter bridge, which is operated under microprocessor control. A main controller is linked to each of the PCUs for controlling the generators 22. Depending on the power output required from the gas turbine generator 1, the controller may activate any number and combination of generators via the PCUs. For example, for maximum power demand all of the generators 22 may be activated, while for lower demand selected generators 22 may be decoupled from the system by electrically deactivating them using the PCU. Thus, the gas turbine generator 1 is able to rapidly respond to variations in power demand through electrical activation and deactivation of the multiple generators 22 while maintaining the turbine 4 at its optimum speed.

In arrangements of the prior art in which direct drive in transferred along a common axis to a single generator, a gear box must be included between the turbine and the generator, adding complexity to the system and increasing the length and weight of the generator. In addition, a linearly arranged gear box of this type presents alignment problems, particularly for larger power generators having components of significant weight. Alignment of the frame and supports for such larger power systems also becomes problematic due to the size and weight of the components involved. In addition, in such systems, the isentropic translational stiffness and rotational stiffness if the couplings linking the elements of the system are difficult to analyse and present operational difficulties, in part because the higher order modes (eigenvalues) are close to and influenced by each other.

These problems are addressed by the present invention in which multiple generators 22 are provided, which are radially offset from the drive axis, rather than a single generator linearly arranged with the drive axis. As such, the length of each generator may be kept well within the maximum rotor length, thereby preventing damage to the magnetic core and minimizing the weight of each generator. Furthermore, radially offsetting the generators 22 from the drive shaft 7 using the geared drive arrangement enables the generators to be positioned parallel and adjacent to the drive shaft 7, thereby minimising the overall length and hence weight of the gas turbine generator 1. The provision of multiple generators 22 also enables the power output of the gas turbine generator 1 to be easily varied by switching the generators 22 in and out of use, as opposed to the single fixed generator arrangement of the prior art.

It will be appreciated that in further embodiments various modifications to the specific arrangements described above and shown in the drawings may be made, without departing form the scope of the invention as defined by the claims. For example, any suitable number of generators may be provided, and the generators may be arranged other than radially about the drive shaft. In addition, while the drive means is described as being a geared arranged, other suitable drive means may be utilised.

1. A gas turbine generator comprising:
a combustor,
a turbine driven by the combustor,
a compressor;
a drive shaft linking the turbine and the compressor along a common rotational drive axis; and
at least one electrical generator comprising a rotor and a stator;
wherein the rotational axis of the generator rotor is radially offset from the drive axis, and drive means is provided which connects the generator rotor to the drive shaft such that rotation of the drive shaft causes rotation of the generator rotor.

2. The gas turbine generator of claim 1, wherein the rotor comprises a permanent magnet secured to a rotor shaft.

3. The gas turbine generator of claim 2, wherein the permanent magnet is at least partially surrounded by a sleeve configured to urge the magnet against the rotor shaft.

4. The gas turbine generator of claim 1, wherein the rotational axis of the generator rotor is oriented substantially parallel to the drive axis.

5. The gas turbine generator of claim 1, wherein the drive means comprises a drive gear connected to and axially aligned with the drive shaft, and a rotor gear connected to the at least one generator rotor and linked to the drive gear such that rotation of the drive gear by the drive shaft causes rotation of the rotor gear and hence the rotor.

6. The gas turbine generator of claim 5 further comprising an idler gear intermediate the drive gear and the rotor gear.

7. The gas turbine generator of claim 6, wherein the idler gear is mounted on a flexible gear support configured to permit self-alignment of the idler gear.

8. The gas turbine generator of claim 1, wherein the at least one generator comprises a plurality of electrical generators.

9. The gas turbine generator of claim 8, wherein the rotational axes of the plurality of generators are radially spaced from the drive axis.

10. The gas turbine generator of claim 9, wherein the plurality of generators are axially positioned in line with at least a portion of the drive shaft.

11. The gas turbine generator of claim 8, wherein each of the plurality of electrical generators may be selectively and independently deactivated to vary the total electrical power output of the gas turbine generator.

12. The gas turbine generator of claim 10, wherein each of the plurality of electrical generators is provided with a dedicated power control unit which is used to selectively deactivate the electrical generator

13. The gas turbine generator of claim 12 further comprising a controller connected to each of the power control units and configured to cause the power control units to selectively deactivate one or more of the electrical generators based on a required power output for the gas turbine generator.

14. A gas turbine generator comprising:
a combustor;
a turbine driven by the combustor;
a compressor driven by the turbine; and
a plurality of electrical generators driven by the turbine.

15. The gas turbine generator of claim 14, wherein the plurality of generators are driven by the turbine via a drive train.

16. The gas turbine generator of claim 14, wherein each of the plurality of electrical generators may be selectively and independently deactivated to vary the total electrical power output of the gas turbine generator.

17. The gas turbine generator of claim 16, wherein each of the plurality of electrical generators is provided with a dedicated power control unit which is used to selectively deactivate the electrical generator

18. The gas turbine generator of claim 17 further comprising a controller connected to each of the power control units and configured to cause the power control units to selectively deactivate one or more of the electrical generators based on a required power output for the gas turbine generator.

19. The gas turbine generator of claim 15, wherein each of the electrical generators is removably coupled to the drive train such that it may be selectively mechanically decoupled from the drive train.

20. A gas turbine generator comprising:
a combustor;
a turbine driven by the combustor;
a compressor;
an electrical generator driven by the turbine, and
a drive shaft for linking the turbine and the compressor, the drive shaft having a first end configured for connection to the turbine and an opposing second end configured for connection the compressor, wherein at least one of the first and second ends comprises a mechanically interlocking connector configured to allow sliding disengagement of the drive shaft from at least one of the turbine and the compressor respectively.

21. The gas turbine generator of claim 20, wherein the mechanically interlocking connector comprises a spline formed on one of the drive shaft and the at least one of the turbine and the compressor which is configured to be received within a corresponding mating section on the other of the drive shaft and the at least one of the turbine and the compressor.

22. The gas turbine generator of claim 21, wherein both the first and second ends of the drive shaft comprise splines configured to be received within corresponding mating sections on the turbine and the compressor respectively.

23. The gas turbine generator of claim 20, wherein the generator is driven by the turbine via a drive train and the generator is connected to the drive train by to an interlocking mechanical connector which enables sliding disengagement of the generator from the drive train.

24. The gas turbine generator of claim 23, wherein the interlocking mechanical connector comprises a plurality of spigots extending from one of the generator and the drive train which are received within corresponding apertures on the other of the generator and the drive train enabling sliding disengagement of the two.

25. (canceled)
